(19) United States
(12) Patent Application Publication
(10) Pub. No.: US 2002/0088003 A1
(43) Pub. Date: Jul. 4, 2002

(54) MAC redundancy in cable network headend

(76) Inventor: Dror Salee, Tel-Aviv (IL)

Correspondence Address: TEXAS INSTRUMENTS INCORPORATED, P O BOX 655474, M/S 3999, DALLAS, TX, 75265

(21) Appl. No.: 09/894,748

(22) Filed: Jun. 27, 2001

Related U.S. Application Data
(60) Provisional application No. 60/214,533, filed on Jun. 27, 2000.

(51) Int. Cl. H04N 7/173

(52) U.S. Cl. 725/111

(57) ABSTRACT

A headend of a cable network data communication system utilizes redundant cable modem termination system (CMTS) receiver or transmitter components set in master-slave timer synchronization relationships to reduce resynchronization delays with connected cable modems (CMs) at swap-out. The counts T of timers driven by common or different CMTS master clocks reset to pre- or dynamically set count numbers P for all redundant components in response to synchronization pulse outputs given when the timer of the master reaches its end of cycle time. In one option, selection of the master is set dynamically. In other options, operation of the master is monitored for calibration, parameter equalization and automatic swap-out between master and slaves.

### CROSS-REFERENCE TO RELATED APPLICATIONS

This application claims the benefit under 35 U.S.C. §119 of provisional application Serial No. 60/214,533, filed Jun. 27, 2000, which, together with the references cited below, is incorporated herein by reference.

### BACKGROUND OF THE INVENTION

This invention relates generally to digital data communication over cable television (CATV) networks and the like; and, in particular, to increasing reliability through redundancy in a cable network headend.

A general description of a CATV network installation of the type to which the present invention finds application can be found in Dr. Walter Ciciora, An Overview of Cable Television in the United States (updated 1995 ed. Cable Television Laboratories, Inc.), currently posted on the CableLabs® Internet website at www.cablelabs.com. Other background information relating to communication of data over cable networks, such as the transfer of internet protocol (IP) data packet traffic, is given in data-over-cable service interface specification (DOCSIS) publications such as DOCSIS Radio Frequency Interface Specification SP-RFI-105-991105 (Interim specification 1999 Cable Television Laboratories, Inc.) posted on the same website.

In a data-over-cable service communication system, an all coaxial or hybrid fiber/coax (HFC) cable network provides broadband bidirectional digital communications using fiber optic and/or coaxial cable lines between a cable system distribution hub or headend and subscriber premises or customer locations. The transmission path is realized at the headend by a cable modem termination system (CMTS) and at each customer location by a cable modem (CM). A typical data-over-cable system architecture is shown at FIGS. 1-2 of the DOCSIS Radio Frequency Interface Specification referenced above.

The CMTS controls all data flows to and from the CMs, including data from the cable service provider's internet backbone. The basic unit for transfer of data between the CMTS and the CM is a variable length frame defined in the media access controller (MAC) layer of the system. In addition to handling data transfer framing, the MAC layer is also used for network management and configuration, such as for timing synchronization or “synch.” Timing synch is needed not only for local framing, encoding, decoding and similar usual data communication processes, but also for CMTS control of time division multiple access (TDMA) multiplexed transmissions in the upstream direction from the CMs to the CMTS. This TDMA control is accomplished by transmitting timestamp information, in the form of the current count state of an incrementing (viz. 32-bit) binary counter clocked with a CMTS clock, at periodic intervals from the CMTS to the CM. Since the upstream data flows must be transmitted at exact times, the CMTS clock serves as a master clock for all CMs attached to it. When a CM is initialized, ranging requests are used to determine what CM clock corrections are needed to bring about timing synch lock. Maintaining continuous time synch between the CMTS and CMs is important. Functional interruptions that lead to synch disruption can cause quality of service and other degradation issues, so should be minimized.

The headend is a complicated principal part of a cable digital data communication network and contains many hardware and software components that may stop functioning. Hence it is very important to maximize its reliability and minimize its unavailability time. Redundancy between different parts of the headend system, wherein redundant components can replace malfunctioning ones, is an effective means of increasing reliability. Redundancy can be implemented on a one-to-one or one-to-many ratio basis. This invention provides apparatus and methods to enable maximizing redundancy while minimizing disruption in a headend part of a cable data network system. Without apparatus and methods as described herein, switching between headend units may result is customer premises equipment (CPE) units losing synch, and going through a long process of signal search, ranging and registration, resulting in unavailability of service for seconds or even minutes. With use of the proposed apparatus and methods, unavailability time may be greatly reduced (viz. to no longer than a few tens of milliseconds, at most).

### SUMMARY OF THE INVENTION

This invention comprises apparatus and methods to achieve redundancy with minimal timing synch loss disruption between components and modules of a cable network digital data communication system. The methods enable different modules or boards of a digital cable headend system, containing a receiver or a transmitter, to replace each other during system operation without a noticeable impact on system functionality and performance.

### BRIEF DESCRIPTION OF THE DRAWINGS

Embodiments of the invention have been chosen for purposes of illustration and description, and are described with reference to the accompanying drawings, wherein:

FIG. 1 is a block diagram of a cable network headend wherein two CMTS MAC chips are synchronized and can replace each other in accordance with the principles of the invention; and

FIG. 2 is a block diagram of a headend employing a transmission monitor for switching to backup transmission.

Throughout the drawings, like reference numerals are used to refer to like elements.

### DETAILED DESCRIPTION OF THE INVENTION

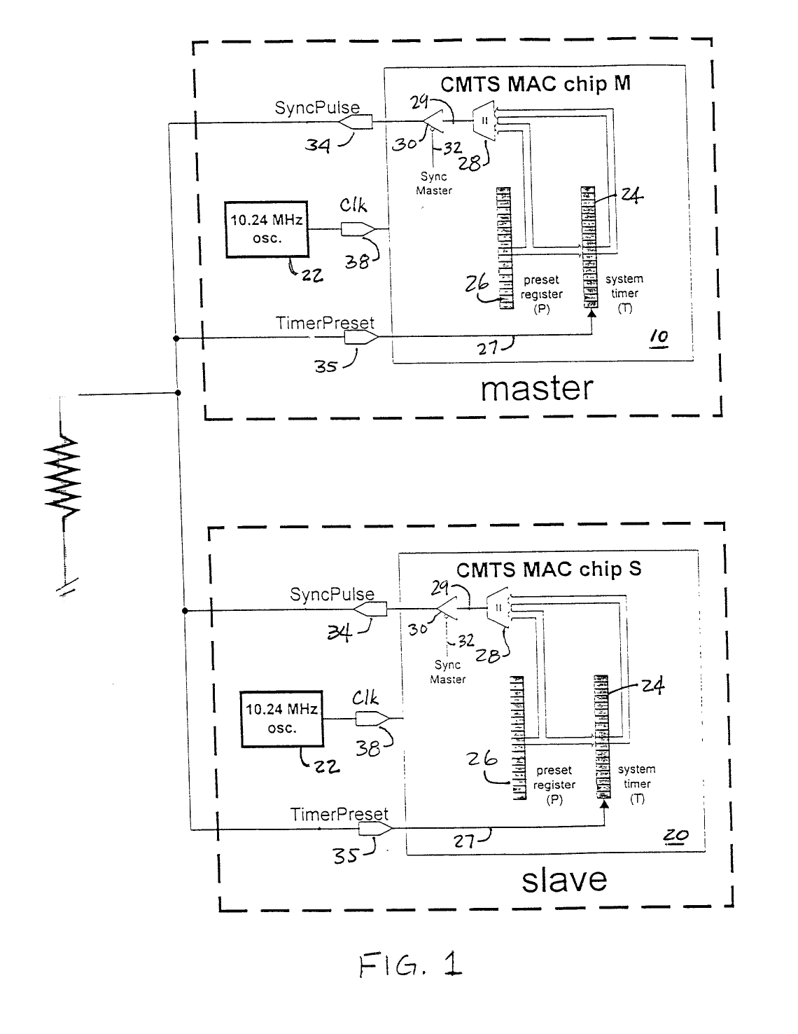

FIG. 1 shows a block diagram of an implementation to achieve increased headend reliability in a cable network system through synchronized redundancy in media access controller (MAC) components (viz. integrated circuit chips) of a cable modem termination system (CMTS). Timing synchronization between the CMTS at the service provider headend and various cable modems (CMs) at respective customer locations of the network is achieved in the usual way. Timing synchronization between headend redundant MAC components is achieved by configuring one MAC chip 10 as a sync master M and one or more other MAC chips 20 as sync slaves S. The allocation of which chip 10 or 20 acts as the master can be predesignated or done on a dynamic basis under MAC processor control. The slaves 20 are continuously synchronized to the master 10, and each slave can serve as a “hot” backup for the master or for another slave. If the master 10 fails, a slave 10 can be set as the new master. The old master can then be replaced with a new element that can then be slaved to the new master.

The FIG. 1 embodiment shows an example redundancy implementation using two DOCSIS specification compliant MAC chip circuits 10 and 20 in a CMTS. The CMTS is located at a cable television (CATV) system headend or distribution hub, and serves to provide complementary functionality to connected CMs to enable data connectivity to a wide-area network (WAN) which enables internet access. MAC chips 10, 20 may be identical integrated circuit elements mounted on identical plug-in packages, modules or boards. Each chip 10, 20 is clocked by a common or separate identical clock oscillator 22. Each chip 10, 20 includes a system timer 24, a timer preset register 26 and a comparator 28. The timer 24 may be an incrementing binary x-bit counter clocked by its respective clock oscillator 22, configured in the usual CMTS timestamp timer way. The timer preset register 26 may be a binary x-bit register connected via a data bus to the system timer 24 to transfer a preset digital number P into the count register of timer 24 upon receipt of a preset signal at a timer preset input 27 of the timer 24. The timer 24 and preset register 26 are both connected via data buses to the comparator 28, which serves to compare the incremented time T in the timer 24 with the preset time P in the register 26 and provide a signal to a SyncPulse output 29 whenever the timer T reaches the preset time P (viz. whenever T=P). The chips 10, 20 also include a switch or gating element such as a buffer 30 at the output of comparator 28 which is controlled by a SyncMaster input 32. The backplane of the CMTS into which the components 10, 20 are plugged includes circuitry for commonly connecting the SyncPulse and TimerPreset terminals 34, 35 of the components 10, 20, as shown. The SyncMaster input 32 thus functions to select which of chips 10, 11 provides the SyncPulse signal through terminal 34 to the backplane as an output to the TimerPreset terminals 34 and system timer inputs 35 of the other components 10, 20.

The SyncMaster signal for each chip 10, 20 can be dynamically set under processor control to select which chip 10, 20 acts as master. In operation, for the configuration illustrated in FIG. 1, signals are applied at the SyncMaster inputs of buffers 30 to enable buffer 30 of CMTS MAC chip 10 but disable buffer 30 of CMTS MAC chip 20. In response to clock pulses received at terminals 38 from oscillators 22, the count register of each system timer 24 increments, and comparator 28 compares the count T of timer 24 with the preset count number P set in register 26. When the count T of timer 24 matches the preset count number P, the comparator output 29 signals a match. However, only the enabled buffer 30—that of the designated master 10—passes the match signal to the SyncPulse output terminal 34. The buffer 30 of the slave 20 blocks the same signal from passing to the terminal 34 of slave 20. The TimerPreset terminals 35 (and, thus, the reset inputs 27 of timers 24) of all chips 10, 20 are normally held at a default logical state (for example, a logical “low” or “0” state in the FIG. 1 illustration) different from the logical state of the match signal (viz. logical “high” or “1” in FIG. 1). When the match signal is sent to SyncPulse terminal 34 of master 10, it is received at the terminals 35 of all chips 10, 20, whereupon the timers 24 are reset and loaded with the preset count number P from the connected register 26. This has no unusual effect on the timer operation of the master 10 for which comparator 28 has just determined that the register contents of 24, 26 match (T=P), but acts to reset the timer 28 of the slave 20 in sync with the timer 28 of master 10 even if the count of the slave timer 24 is not a match. The contents of registers 26 can, of course, also be controlled by the processor to vary the preset count number, if desired.

Redundant MAC chips 10, 20 are on separate boards with separate timers, not necessarily driven by the same DOCSIS clock (viz. 10.24 MHz CMTS master clock) oscillator 22. Oscillator frequency may vary within the DOCSIS specified limit (±5 PPM; see above Radio Interface Specification at Section 4.3.7), therefore the system timers 24 of the separate MACs may drift, and the timers may get out of timestamp count synchronization with each other. Over many counter cycles without periodic resynchronization of the redundant chips, this could lead to long time delays needed to reestablish synch between the CMTS and CMs whenever one chip 10, 20 is taken out of service and replaced. This timestamp synch loss time delay is avoided (or, at least, significantly reduced) with the described master-slave time synch implementation. For the given embodiment, chip 10 is configured as the sync master, and chip 20 as a sync slave. Which is the master and which is the slave is a matter of choice, both being configured to act as either. Chip 20 has a SyncPulse output that is kept at high impedance. Once the count T of master 10 internal timer 24 reaches the pre-programmed time P stored in register 26, a SyncPulse pulse is generated at terminal 34 of the master 10. This pulse causes the slave device 20 to load its system timer 24 to the preset time P from register 26. Since the count T of the system timer 26 equals the preset value P once each cycle (approx. 7 minutes), a host controller may update the value P (for all chips) after synchronization has been performed, to achieve better accuracy by more frequent pulses.

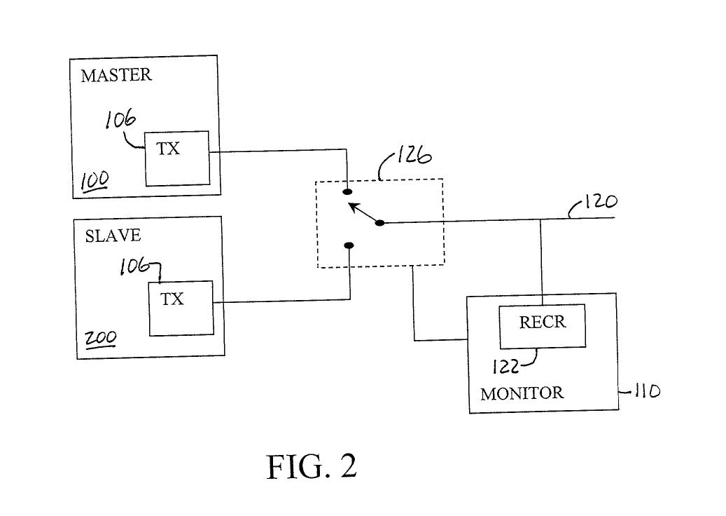

The downstream transmitted signal can be monitored for failure as shown in FIG. 2. While failure in a cable network headend module or component 100 containing a receiver can be monitored via the input data flow, a failure in a module or component 100 containing a transmitter 106 may be noticeable only at the RF output of the module. For this reason, a monitoring circuit element 110 is connected to monitor the transmitted RF signal output 120 to the downstream coax cable. Monitoring circuit 110 contains a receiver 122, which is constantly locked to the transmitted downstream signal. In case of signal failure, monitor 110 detects signal loss and generates a failure signal, which causes switching (indicated schematically at 126) between the malfunctioning transmission unit 100 and the back-up transmission unit 200. One monitoring unit 110 may monitor a single downstream signal, or a few signals by periodically scanning them, using a single tuner or a few tuners.

The criterion for signal loss detection by monitor 110 can be established in various ways. For example, signal loss can be detected based on a drop in mean squared error (MSE) of the signal at 120, or through detection of erroneous forward error correction (FEC) frames, or through detection of erroneous MAC frames. The malfunction determination criterion will be the appearance of one of the detected conditions for a contact period of time (such as, for example, on the order of a few milliseconds).

The monitor 110 can also be used as a feedback (as indicated by the dot-dashed lines) to intially or periodically calibrate the system, such that analog signal parameters (i.e. signal level and signal frequency) are set similar between the transmitting module 100 and its backup 200. In this case, the switch 126 is set to monitor first one, then the other, of the components 100, 200 and set the transmission parameters of the slave or standby unit or units to ensure a seamless transfer when a designated master fails. For calibration where more than one redundant unit 200 exists, a previously calibrated one of the redundant units 200 can be set as a temporary master, while remaining slaves 200 are calibrated against the master 100.

A method for switching between simultaneously transmitted downstream signals can also be established. When downstream signal loss at 120 is recognized (as, for example, by using one of the above approaches), the downstream output of the headend system can be automatically switched to a back-up module 200 transmitting identical data. The back-up module MAC 200 is synchronized to the MAC 100 of the transmitting module. In contrast to the situation where data for transmission is sent only to one component 100, 200 at a time for transmission, depending on which is currently acting as master, this scenario contemplates that data for transmission is transferred in parallel to both (viz. some or all, if more than two) modules 100, 200. This will decrease the time needed to get the back-up transmission going.

Detection time at the monitoring module, plus signal switching time, will however still result in some discontinuity in the downstream signal. Also, after switching, certain analog parameters (even if calibrated periodically) will still be different (i.e. signal level, center frequency, symbol phase). In order to shorten unavailability of service at the CPE CM units, the following settings can be applied at the CM side. Once a modem CM is synchronized to the CMTS, its receiver can be programmed to a mode wherein after signal loss, it will search for a signal with similar parameters (i.e. modulation constellation, frequency, signal level) to the dropped signal. The modem will be made tolerant to signal loss for a maximum period (i.e. Lost SYNC Interval, which is 600 ms for a DOCSIS system).

The principles of the invention as illustrated above enable redundancy and “hot swap” replacing of headend circuit modules or components containing an upstream receiver or downstream transmitter, without loss of service for a period longer than a few tens of milliseconds.

Those skilled in the art to which the invention relates will appreciate that various substitutions and modifications may be made to the described embodiments, without departing from the spirit and scope of the invention as defined by the claims.

What is claimed is:

1. A headend of a cable network data communication system, comprising:
a first cable modem termination system (CMTS) circuitry component having a receiver or transmitter, the first component including a first system timer adapted to be incremented by clock pulses, a first comparator connected to said first timer for determining when the first timer has reached a designated count, and a first reset circuit connected to the first timer for resetting the first timer in response to a reset signal;
a second CMTS circuitry component having a receiver or transmitter, the second component being adapted to serve as a swap-out replacement for the first component, and the second component including a second system timer adapted to be incremented by clock pulses, a second comparator connected to the second timer for determining when the second timer has reached a designated count, and a second reset circuit connected to the second timer for resetting the second timer in response to a reset signal; and
circuitry connected to the first and second components for connecting the first comparator to provide the reset signal to the second reset circuit.

2. A headend of a cable network data communication system, comprising:
a first cable modem termination system (CMTS) circuitry component having a receiver or transmitter, the first component including a first system timer adapted to be incremented by clock pulses, a first comparator connected to said first timer for determining when the first timer has reached a designated count, and a first reset circuit connected to the first timer for resetting the first timer in response to a reset signal;
a second CMTS circuitry component having a receiver or transmitter, the second component including a second system timer adapted to be incremented by clock pulses, a second comparator connected to the second timer for determining when the second timer has reached a designated count, and a second reset circuit connected to the second timer for resetting the second timer in response to a reset signal; the first and second components being adapted to serve as a swap-out replacements for each other; and
circuitry connected to the first and second components for selectively connecting either the first comparator to provide the reset signal to the second reset circuit, or the second comparator to provide the reset signal to the first reset circuit.

3. A method for establishing timer synchronization between redundant active and standby circuit components of a headend of a cable network data communication system, comprising:
providing a first cable modem termination system (CMTS) circuitry component including a system timer incremented by clock pulses;
providing a second CMTS circuitry component including a system timer incremented by clock pulses; the second component being adapted to serve as a swap-out replacement for the first component;
resetting the second component timer when the first timer has reached a designated count.
